(19) United States
(12) Patent Application Publication
(10) Pub. No.: US 2003/0026420 A1
(43) Pub. Date: Feb. 6, 2003

(54) Copyright protection in personal computers

(75) Inventor: Hideki Makino, Hamamatsu-shi (JP)

Correspondence Address: Pillsbury Winthrop LLP, Intellectual Property Group, Suite 2800, 725 South Figueroa Street, Los Angeles, CA, 90017-5406, US

(73) Assignee: Yamaha Corporation, Hamamatsu-shi (JP)

(21) Appl. No.: 10/212,327

(22) Filed: Aug. 5, 2002

(30) Foreign Application Priority Data
Aug. 6, 2001 (JP) P2001-238174

(51) Int. Cl. H04L 9/00

(52) U.S. Cl. 380/201; 705/57

(57) ABSTRACT

Copyright protection is ensured in personal computers when reproducing and outputting audio files or media data representing audio data and/or picture data. An application program is used to read copyright information that is attached to the media data and to write it into a registry. Upon receipt of a play request that is made by the user operating the personal computer, a device driver is activated to read the copyright information from the registry. The read copyright information is compared with a default value representing the prescribed criterion in copyright protection, so that the device driver automatically attaches the default value or the read copyright information, which is equal to or above the default value, to the output data that are output from the personal computer reproducing the media data.

### BACKGROUND OF THE INVENTION

1. Field of the Invention

This invention relates to copyright protection methods and apparatuses for use in electronic information devices and tools such as personal computers and personal digital assistant (PDA) devices, in which copyright protection information is automatically added to digital readouts such as audio files and media data.

2. Description of the Related Art

Recent personal computers are capable of receiving audio files distributed thereto via the Internet and reproducing the received files, and they can reproduce music CD-ROMs or video DVDs (i.e., Digital Versatile Disk). In addition, recent personal computers can reproduce audio files to provide digital audio data via digital output terminals. Digital audio data can be recorded on mini disks (MDs) or digital audio tapes (DATs) in player/recorders or decks. Alternatively, digital audio data can be reproduced using amplifiers.

Recently, copyrights may be frequently highlighted to secure ‘strict’ protections against unauthorized copying with respect to data distributions over the Internet. However, conventional personal computers may not provide appropriate countermeasures in copyright protections for audio files and various media. Specifically, conventional personal computers may not be adequately set up to provide proper copyright information in outputting audio files and media data via digital output terminals thereof even though audio files or media data distributed from external systems are accompanied with copyright information. That is, there is a problem in that copyright protection cannot be always guaranteed in personal computers. In addition, conventional personal computers merely output digital data without paying attention to protection of the original author's right with respect to the other data which are not accompanied with copyright protection.

### SUMMARY OF THE INVENTION

It is an object of the invention to provide a copyright protection method and apparatus that automatically apply copyright protection to digital readouts, in particular for audio files, in personal computers.

This invention reliably ensures copyright protection in personal computers when reproducing and outputting audio files or media data representing audio data and/or picture data. An application program is used to read copyright information that is attached to the media data and to write it into a registry. Upon receipt of a play request that is made by the user operating the personal computer, a device driver is activated to read the copyright information from the registry. The read copyright information is compared with a default value representing the prescribed criterion in copyright protection, so that the device driver automatically attaches the default value or the read copyright information, which is equal to or above the default value, to the output data that are output from the personal computer reproducing the media data.

Specifically, the device driver is installed in the personal computer to make comparisons and evaluations with respect to the copyright information attached to the media data. That is, when the read copyright information is equal to or above the default value, the device driver directly attaches the read copyright information to the output data of the personal computer. When the read copyright information does not match the default value, the device driver automatically attaches the default value, instead of the read copyright information, to the output data of the personal computer. If no copyright information is attached to the media data, the default value is attached to the output data of the personal computer.

The copyright information may represent authorization to copy various materials such as audio data and picture data for individual persons, for example. Hence, the copyright information may allow copying of materials only one time, or it may completely disallow copying of materials. The default value may be set to allow copying of materials only one time, for example.

### BRIEF DESCRIPTION OF THE DRAWINGS

These and other objects, aspects, and embodiments of the present invention will be described in more detail with reference to the following drawing figures, in which:

FIG. 1 is a simplified block diagram showing the overall system configuration realizing a copyright protection method in accordance with a first embodiment of this invention;

FIG. 2 is a block diagram showing the overall system configuration of a personal computer incorporating copyright protection functions in accordance with a second embodiment of the invention;

FIG. 3 is a block diagram showing the internal configuration of an audio controller shown in FIG. 2; and

FIG. 4 is a flowchart showing operations of a device driver shown in FIG. 1.

### DESCRIPTION OF THE PREFERRED EMBODIMENTS

This invention will be described in further detail by way of examples with reference to the accompanying drawings.

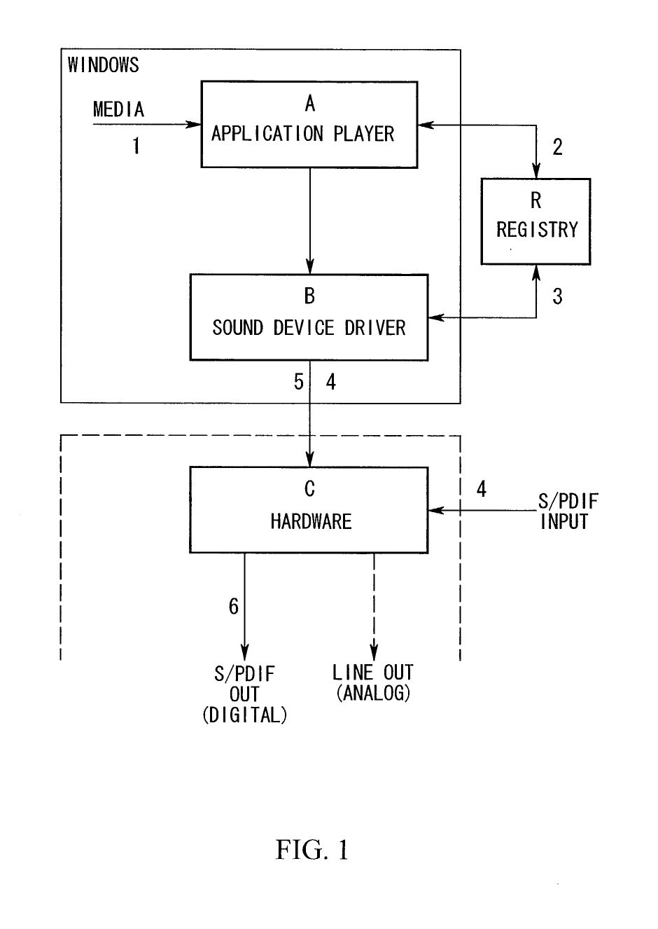

FIG. 1 is a block diagram showing the overall system configuration realizing a copyright protection method in accordance with the first embodiment of this invention. Herein, the system is constituted by four devices or elements, i.e., a player A, sound device driver B, hardware C, and registry R. Basically, the first embodiment can be realized by six steps or means, which will be described below.

1. Media Reproduction Request

There are provided media (or digital storage media such as CDs, DVDs, and memory cards), which are accompanied with copyright protection. The player A reads the copyright protection from the media.

2. Encryption or Encoding

The player A reflects the copyright information onto the prescribed location of the registry R, which is set up in advance in accordance with the existing technology such as the Windows (registered trademark), wherein the copyright information is subjected to encryption or encoding to avoid unwanted analysis by other machines.

3. Analysis

In response to a reproduction request, the sound device driver B read the information of the registry R to analyze it.

4. Comparison

If the read information is valid, it is compared with the default value that is held in the sound device driver B. Herein, S/PDIF input is also counted as the subject of the comparison.

5. Strict Setting

Through the comparison, the sound device driver B sets a more strict value to the hardware C. Specifically, the more strict standard is reflected on digital readouts as to whether the original can be copied one time or cannot be copied without authorization (or permission) with respect to each generation in media.

6. Output

The aforementioned processing results are output via S/PDIF. ‘LINE OUT’ indicates an analog output, which is irrelevant to this invention.

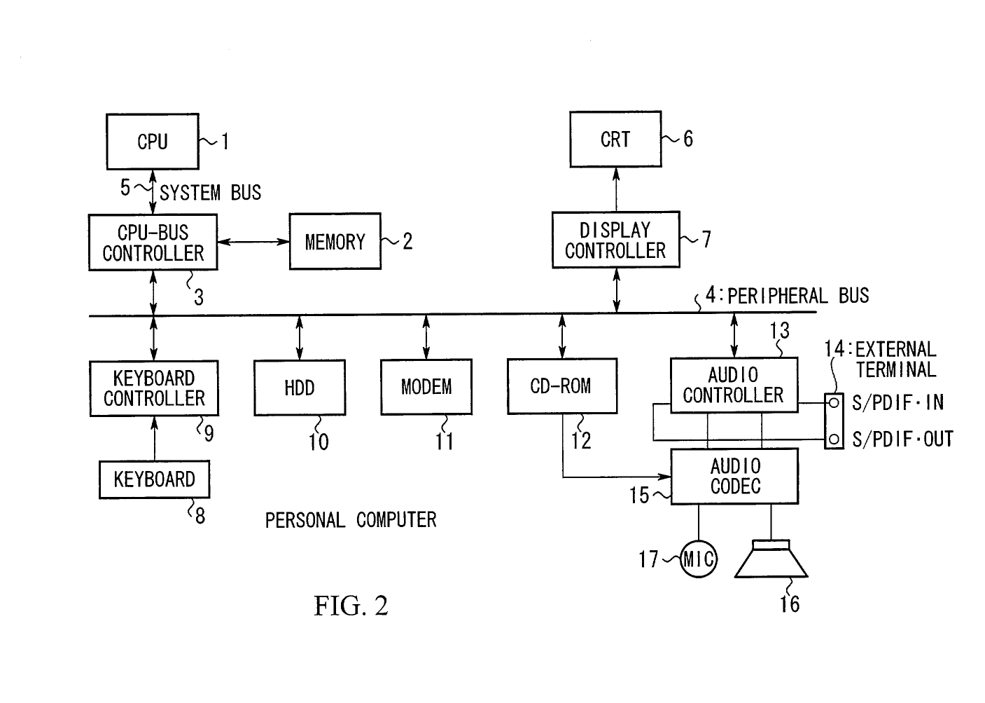

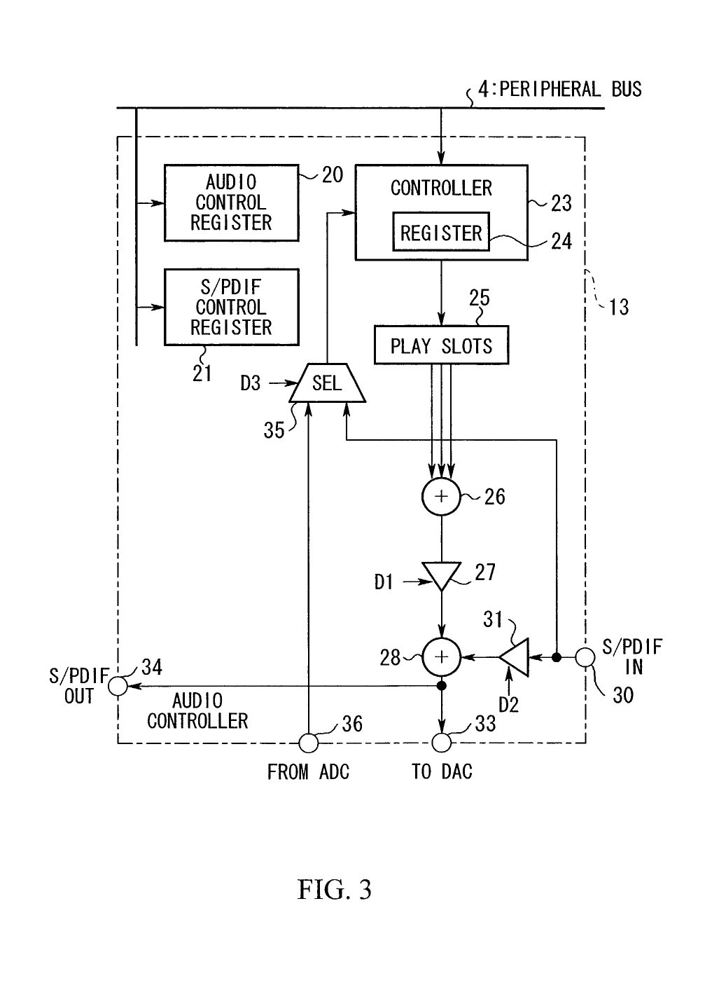

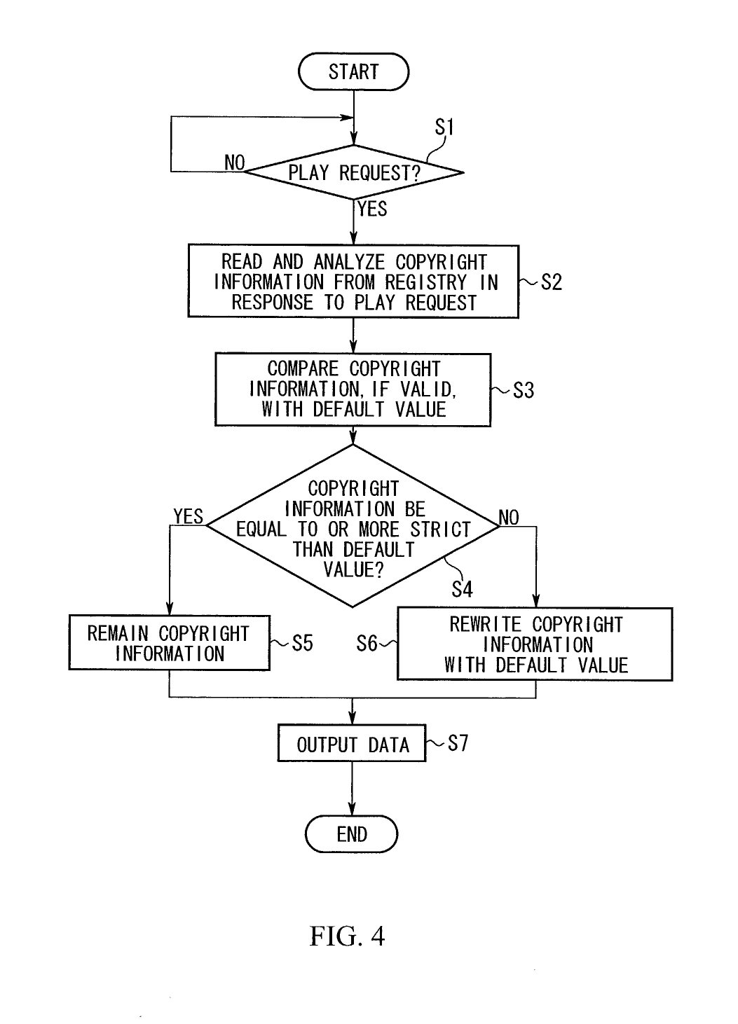

FIG. 2 is a block diagram showing the overall system configuration of a personal computer and the like in accordance with the second embodiment of this invention. The system configuration of FIG. 2 may be an expanded form in design compared with the configuration of FIG. 1. FIG. 3 shows the internal configuration of an audio controller 13 shown in FIG. 2. FIG. 4 is a flowchart for explaining the overall operation of the system shown in FIG. 2.

In FIG. 2, reference numeral 1 designates a central processing unit (CPU), and reference numeral 2 designates a memory that comprises a read-only memory (ROM) and a random-access memory (RAM). Reference numeral 3 designates a CPU-bus controller that is interconnected with the memory 2 and is also connected with the CPU 1 via a system bus 5. The CPU-bus controller 3 also provides interconnections with other elements via a peripheral bus 4. Reference numeral 6 designates a cathode-ray tube (CRT) display. Reference numeral 7 designates a display controller for driving the CRT display 6. Reference numeral 8 designates a keyboard. Reference numeral 9 designates a keyboard controller that outputs key data over the peripheral bus 4 in response to manual operations applied to keys of the keyboard 8. Reference numeral 10 designates a hard-disk drive (HDD) for driving hard disks therein. Reference numeral 11 designates a modem (i.e., modulator-demodulator) that allows the personal computer to be connected with telephone lines. Reference numeral 12 designates a CD-ROM drive for driving a CD-ROM inserted therein.

Reference numeral 13 designates an audio controller, details of which will be described later in conjunction with FIG. 3. Reference numeral 14 designates an external terminal set, which includes a ‘S/PDIF-IN’ terminal applied with digital audio data from the external device (not shown) and an ‘S/PDIF-OUT’ terminal for outputting digital audio data towards the external device. These S/PDIF-IN and S/PDIF-OUT terminals are both connected with the audio controller. Reference numeral 15 designates an audio codec (i.e., coder-decoder) having digital-to-analog and analog-to-digital conversion functions. Specifically, the audio codec 15 converts audio data output from the audio controller 13 or the CD-ROM drive 12 to analog signals, which are supplied to a speaker 16. In addition, the audio codec 15 converts audio signals, representing speech or sound picked up by a microphone 17, to digital data, which are supplied to the audio controller 13.

Next, the internal configuration of the audio controller 13 will be described with reference to FIG. 3. Herein, reference numeral 20 designates an audio control register, which is written with the sampling frequency and data format of reproduced audio data as well as control data for controlling or managing play/record positions of audio data. Reference numeral 21 designates an S/PDIF control register, which is written with specific data for output controls and channel status controls. Reference numeral 23 designates a controller that controls play channels, which are written with multi-channel audio data supplied via the peripheral bus 4. The controller 23 contains a register 24, which is written with management data with regard to multiple play slots 25. The aforementioned registers 20, 21, and 24 are each controlled in writing operations by the device driver (i.e., software) for managing the audio controller 13 and the audio codec 15.

The play slots 25 correspond to the play channels respectively, wherein audio data of each channel are temporarily stored and are output to an adder 26. The adder 26 adds together output data of the play slots 25 in relation to the respective channels, so that the addition result is supplied to a multiplier 27.

The multiplier 27 multiplies the output data of the adder 26 with data D1, which are supplied thereto from the audio control register 20, so that the multiplication result is supplied to an adder 28. Reference numeral 30 designates a terminal that receives data input to the S/PDIF-IN terminal of the external terminal set 14 shown in FIG. 2. Reference numeral 31 designates a multiplier that multiplies data of the terminal 30 with data D2, which are supplied thereto from the S/PDIF control register 21, so that the multiplication result is supplied to the adder 28. The adder 28 adds together the outputs of the multipliers 27 and 31, so that the addition result is delivered to terminals 33 and 34. The data of the terminal 33 are supplied to a digital-to-analog converter (not shown) provided inside of the audio codec 15. The data of the terminal 34 are supplied to the S/PDIF-OUT terminal of the external terminal set 14.

Reference numeral 35 designates a selector having two input terminals and one output terminal. Herein, the first input terminal receives the output data of an analog-to-digital converter (not shown) provided inside of the audio codec 15 via a terminal 36. The second input terminal receives the data of the terminal 30. In response to 1-bit data D3 supplied from the S/PDIF control register 21, the selector 35 selects either the first input or second input, which is output to the controller 23.

Next, audio data play operations executed by the personal computer will be described with reference to FIGS. 1 and 4, wherein descriptions are provided in relation to an example in which audio data written on hard disks in the hard-disk drive 10 or stored in the memory 2 are subjected to reproduction.

When the user operates the keyboard 8 to input an audio data play request, the personal computer starts an application program for ‘play’ (which may be executed by the application player A shown in FIG. 1). By executing the program, the personal computer (actually, CPU 1) reads copyright information of the audio data provided from the hard-disk drive 10 or memory 2. Then, the application program reflects the copyright information onto the prescribed location of the registry R, wherein encryption or encoding (or decoding) is arbitrarily performed to avoid unauthorized analysis. The play request is transferred to the sound device driver B. Incidentally, the registry R is realized by the existing technology to allow the operating system (OS, e.g., Windows (registered trademark)) to temporarily store various types of information.

Next, the specific processing of the sound device driver B (hereinafter, simply referred to as the device driver) will be described with reference to the flowchart of FIG. 4. When the application program provides a play request issued by the user, the decision of step S1 turns to ‘YES’, so that the flow proceeds to step S2 in which the device driver reads and analyzes the copyright information from the registry. If the copyright information is valid, the device driver compares the copyright information with the default value, which may represent a certain criterion in copyright protection and is described in advance (see step S3). When the copyright information is equal to or more strict compared with the default value, the decision of step S4 turns to ‘YES’, so that the flow proceeds to step S5. In step S5, the device driver retains the copyright information. If ‘NO’ in step S4, the flow proceeds to step S6 in which the copyright information is rewritten with the default value. That is, the default value is set to the hardware C shown in FIG. 1.

Specifically, a method of copyright protection for media used in the aforementioned personal computer is as follows:

At first, a decision is made as to whether or not media are accompanied with copyright protection. Hence, there are provided two courses that correspond to prescribed terms, namely, with or without copyright protection. Under the copyright protection secured conditions, there are further provided two courses that correspond to prescribed terms, namely, ‘original’ (allowing copying only one time) and ‘copy’ (blocking unauthorized copying). The device driver describes ‘original’ as the default value in advance. Hence, if the copyright information attached to the audio data prior to reproduction describe ‘no copyright protection’, or if no copyright information is attached to the audio data, the decision of step S4 turns to ‘NO’, so that the flow proceeds to step S6 in which the device driver automatically rewrites the copyright information with the default value. If the copyright information attached to the audio data prior to reproduction describes ‘original’, the decision of step S4 turns to ‘YES’, so that the flow proceeds to step S5 in which the device driver retains the copyright information. Even though the copyright information attached to the audio data prior to reproduction describes ‘copy’, the decision of step S4 turns to ‘YES’, so that the flow proceeds to step S5 in which the device driver retains the copyright information.

Due to the aforementioned steps, the copyright information remains and is still attached to the audio data, or the copyright information is rewritten with the default value that is newly attached to the audio data. The audio data accompanied with the copyright information or default value is supplied to the audio controller 13 via the peripheral bus 4, wherein they are forwarded to the controller 23 shown in FIG. 3 (see step S7 shown in FIG. 4). Then, the audio data are supplied to the audio codec 15 via the play slots 25, adder 26, multiplier 27, adder 28, and terminal 33. Thus, the speaker 16 coupled with the audio codec 15 generates musical tones based on the audio data. In addition, the audio data are also delivered to the S/PDIF-OUT terminal of the external terminal set 14 via the terminal 34. Therefore, it is possible to output the audio data accompanied with the copyright information or default value to the external device via the S/PDIF-OUT terminal.

When audio data are input to the S/PDIF-IN terminal of the external terminal set 14, they are supplied to the audio controller 13, wherein they are forwarded to the controller 23 via the selector 35. Hence, the input audio data are provided onto the peripheral bus 4 from the controller 23 of the audio controller 13 and are then temporarily stored in the memory 2. In this case, the device driver reads copyright information attached to the input audio data stored in the memory 2; then, the device driver compares it with the default value. When the device driver determines that the copyright information is equal to or more strict compared with the default value, it retains the copyright information. In contrast, when the device driver determines that the copyright information is less strict (or loose) compared with the default value, it rewrites the copyright information with the default value. Thus, the input audio data whose copyright information is retained or updated are written into hard disks in the hard-disk drive 10. Incidentally, the device driver automatically deletes the audio data temporarily stored in the memory 2.

Of course, the personal computer allows the user to arbitrarily change the default value, which is set to the device driver.

The aforementioned embodiment is designed in such a way that even though copyright information is not attached to the audio data or picture data, the device driver automatically attaches the default value to them, which may describe ‘original’ (allowing copying only one time). This may ensure or strengthen the author's right in copyright protection with respect to audio data and picture data. Therefore, it is possible to reliably avoid unauthorized copying of media in personal computers over the Internet and the like.

As this invention may be embodied in several forms without departing from the spirit or essential characteristics thereof, the present embodiments are therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

What is claimed is:

1. A copyright protection apparatus applicable to a personal computer that has a function of reproducing audio data and/or picture data and a function of outputting the audio data and/or the picture data, comprising:
a reader for reading copyright information attached to the audio data and/or the picture data; and
a copyright information setting device for automatically attaching the read copyright information to output data, which are output from the personal computer.

2. A copyright protection apparatus applicable to a personal computer that has a function of reproducing audio data and/or picture data and a function of outputting the audio data and/or the picture data, comprising:
a reader for reading copyright information attached to the audio data and/or the picture data;
a comparator for comparing the read copyright information with a default value representing a prescribed criterion in copyright protection; and
a copyright information setting device for when the read copyright information is equal to or more strict compared with the default value, directly attaching the copyright information to output data of the personal computer, and for when the read copyright information is less strict compared with the default value, automatically attaching the default value, instead of the read copyright information, to the output data of the personal computer.

3. The copyright protection apparatus applicable to a personal computer according to claim 2, wherein the default value allows copying only one time.

4. The copyright protection apparatus applicable to a personal computer according to claim 2, wherein the default value can be arbitrarily changed by a user of the personal computer.

5. The copyright protection apparatus applicable to a personal computer according to claim 2, wherein when the reader communicates that no copyright information is attached to the audio data and/or picture data, the copyright information setting device automatically attaches the default value to the output data of the personal computer.

6. The copyright protection apparatus applicable to a personal computer according to claim 3, wherein when the reader communicates that no copyright information is attached to the audio data and/or picture data, the copyright information setting device automatically attaches the default value to the output data of the personal computer.

7. The copyright protection apparatus applicable to a personal computer according to claim 4, wherein when the reader communicates that no copyright information is attached to the audio data and/or picture data, the copyright information setting device automatically attaches the default value to the output data of the personal computer.

8. The copyright protection apparatus applicable to a personal computer according to claim 1, wherein the reader reads the copyright information attached to the audio data and/or the picture data, which are supplied from an external device to an external terminal provided for the personal computer.

9. The copyright protection apparatus applicable to a personal computer according to claim 2, wherein the reader reads the copyright information attached to the audio data and/or the picture data, which are supplied from an external device to an external terminal provided for the personal computer.

10. The copyright protection apparatus applicable to a personal computer according to claim 3, wherein the reader reads the copyright information attached to the audio data and/or the picture data, which are supplied from an external device to an external terminal provided for the personal computer.

11. The copyright protection apparatus applicable to a personal computer according to claim 4, wherein the reader reads the copyright information attached to the audio data and/or the picture data, which are supplied from an external device to an external terminal provided for the personal computer.

12. The copyright protection apparatus applicable to a personal computer according to claim 5, wherein the reader reads the copyright information attached to the audio data and/or the picture data, which are supplied from an external device to an external terminal provided for the personal computer.

13. The copyright protection apparatus applicable to a personal computer according to claim 6, wherein the reader reads the copyright information attached to the audio data and/or the picture data, which are supplied from an external device to an external terminal provided for the personal computer.

14. The copyright protection apparatus applicable to a personal computer according to claim 7, wherein the reader reads the copyright information attached to the audio data and/or the picture data, which are supplied from an external device to an external terminal provided for the personal computer.

15. A copyright protection method applicable to a personal computer that has a function of reproducing audio data and/or picture data and a function of outputting the audio data and/or the picture data to an external device, comprising the steps of:
reading copyright information attached to the audio data and/or the picture data; and
automatically attaching the read copyright information to output data, which are output from the personal computer.

16. A copyright protection method applicable to a personal computer that has a function of reproducing audio data and/or picture data and a function of outputting the audio data and/or the picture data to an external device, comprising the steps of:
reading copyright information attached to the audio data and/or the picture data;
comparing the read copyright information with a default value representing a prescribed criterion in copyright protection;
when the read copyright information is equal to or more strict compared with the default value, directly attaching the read copyright information to the output data of the personal computer; and
when the read copyright information is less strict compared with the default value, automatically attaching the default value, instead of the read copyright information, to the output data of the personal computer.

17. A device driver that is executable based on an operating system installed in a personal computer to perform a copyright protection method comprising the steps of:
upon receipt of a play request that is made by a user operating the personal computer, reading and analyzing copyright information attached to audio data and/or picture data;
comparing the read copyright information with a default value representing a prescribed criterion in copyright protection;
when the read copyright information is equal to or above the default value, directly attaching the read copyright information to output data, which are output from the personal computer; and
when the read copyright information does not match the default value, automatically attaching the default value, instead of the read copyright information, to the output data of the personal computer.
